(19) United States
(12) Patent Application Publication
(10) Pub. No.: US 2007/0094663 A1
(43) Pub. Date: Apr. 26, 2007

(54) Flexible ordered execution mechanism for multi-threaded processors

(76) Inventor: Hossein Arefi Anbarani, Bethesda, MD (US)

Correspondence Address: ERICSSON INC., 6300 LEGACY DRIVE, M/S EVR 1-C-11, PLANO, TX, 75024, US

(21) Appl. No.: 11/258,307

(22) Filed: Oct. 25, 2005

(51) Int. Cl. G06F 9/46

(52) U.S. Cl. 718/102

(57) ABSTRACT

A multi-threaded processor adapted to perform ordered execution, wherein the execution of threads, or code portions, is delayed if, and only if, execution of a thread would violate the ordered execution of a program. The processor initializes a Global Start Register and a Global Finish Register; saves an initial value of the Global Start Register and then increments the Global Start Register upon execution of each code portion requiring ordered execution; increments the Global Finish Register upon completion of execution of the code portion; and, compares the initial value of the Global Start Register with the present value of the Global Finish Register. If the initial value of the Global Start Register is equal to the present value of the Global Finish Register, indicating that no out-of-order execution of code portions has occurred, the processor increments the Global Finish Register; or, if the initial value of the Global Start Register is not equal to the present value of the Global Finish Register, indicating out-of-order execution, it waits for a specified event and then again compares the initial value of the Global Start Register with the present value of the Global Finish Register, repeating until they are equal.

### TECHNICAL FIELD OF THE INVENTION

The present invention is directed, in general, to computer processing systems, and, more specifically, to apparatus and methods for performing ordered execution in multi-threaded processors.

### BACKGROUND OF THE INVENTION

In order to speed up processing, many modern computer system processors include hardware support for parallel execution of software programs. (As used herein, “software” means programs written at any abstraction level to execute on a processor, including programs written at the “assembly” level, sometimes referred to as “firmware.”) In such systems, software program execution is split into what is called “contexts” or “threads,” and some hardware resources, e.g., data registers, are dedicated to each thread, while other resources are shared, e.g., the Arithmetic Logical Unit (ALU). Although program threads execute in parallel over an extended time period, only one thread can execute an instruction and have access to the shared resources at each clock cycle. An arbitrator unit is a hardware module in the processor that is used to schedule program execution among threads. Generally, threads that are ready to execute are scheduled for execution in a “round robin” fashion.

In some applications, there is a need to keep some form of ordered execution between threads. One example is a network processor—a processor dedicated to process data packets that are transmitted in a network—which needs to maintain packet order for packets belonging to the same “flow;” i.e., packets that take the same path through the software program. In order to maintain proper packet order, a mechanism beyond the basic service provided by the processor's arbitrator unit must be employed.

FIG. 1 illustrates the undesired reordering of execution of thread processes, wherein thread 101 and thread 103 represent execution of the same section (or “code portion”) of a program which requires ordered execution. Sub-section A contains an input/output (i/o) operation that must be completed before program execution can continue at sub-section B. As illustrated, the program running on thread 103 starts processing sub-section A after thread 101, but finishes earlier and can start processing sub-section B before thread 101, thereby causing an undesired reordering. It should be noted how threads 101-104 execute one after the other, in a “round robin” fashion, in the first round of execution. When thread 104 is finished, thread 101 could begin execution again, but it is still waiting for an i/o operation to finish and, thus, isn't ready to execute. Thread 102 is ready and next in line so it is executed. When thread 102 is finished, it is thread 103's turn. Although thread 103 has its i/o operation finished after thread 101, unlike thread 101 it is ready to execute when its turn comes up, which results in undesired reordering.

Generally, reordering occurs after an i/o wait. Therefore, for purposes of describing the invention, any reference herein to a program section (or “code portion”) that requires ordered execution assumes the existent of one or multiple context arbitrations, where threads wait for one or multiple i/o operations to finish before they are ready to continue program execution in that section of the code. Of course, a program that does not include any i/o operations does not need to address any reordering issues.

In the prior art, various ordered execution techniques have been used that employ some form of signaling mechanism between threads in order to achieve ordered program execution. A common way to implement such a mechanism is to have each thread wait for a dedicated special signal from the previous thread; once the signal is received, the thread executes until it needs to give up arbitration (i.e., let other threads execute), either because the thread is waiting for the completion of an i/o operation or because the programmer has inserted a voluntary arbitration in the program. Before giving up arbitration, the next thread is signaled and thereby allowed to execute.

FIG. 2 illustrates the application of prior art principles to avoid the undesired reordering of execution of thread processes. FIG. 2 illustrates the same case as in FIG. 1, wherein a prior art ordering mechanism as described above is implemented. As those skilled in the art will recognize, once all threads have executed one time, they have to wait for thread 201 to execute again. Therefore, thread 203 can't execute sub-section B ahead of thread 201. The undesired reordering is thus avoided. The very mechanism by which ordered execution is achieved (i.e., using signaling between threads as described above), however, also causes the main deficiency of such solutions—a thread that can't execute due to a disproportionably long i/o wait will stall all other threads after one round of execution. In FIG. 2, thread 204 and thread 202 are also stalled waiting for thread 201 to execute, despite the fact that they are not executing the same part of the program that requires ordered execution relative to thread 201. Thread 202 would, in fact, be ready to execute in this case if it wasn't waiting for a signal from thread 201. Instead, no thread is executing for an undesired period of time.

Accordingly, there is a need in the art for improved apparatus and methods for performing ordered execution in multi-threaded processors. Preferably, such improved apparatus and methods will eliminate the need for signaling between threads, and which will eliminate the stalling of all other threads if a thread cannot execute due to a long i/o wait state.

### BRIEF SUMMARY OF THE INVENTION

To address the above-discussed deficiencies of the prior art, disclosed are methods for use in multi-threaded processors for performing ordered execution. In general, the method includes the steps of: initializing a Global Start Register, initializing a Global Finish Register and, for each code portion requiring ordered execution during processing, altering the values stored in those registers to provide an indication of reordered execution. Upon execution of a code portion, an initial value of the Global Start Register is saved and then the Global Start Register is incremented. Upon completion of execution of a code portion, the Global Finish Register is incremented. The initial value of the Global Start Register is then compared with the present value of the Global Finish Register. If the initial value of the Global Start Register is equal to the present value of the Global Finish Register, indicating that no out-of-order execution of code portions has occurred, the Global Finish Register is incremented; if the initial value of the Global Start Register is not equal to the present value of the Global Finish Register, indicating reordering of execution, then a specified event is waited for and the step of comparing the initial value of the Global Start Register with the present value of the Global Finish Register is repeated until the initial value of the Global Start Register is equal to the present value of the Global Finish Register.

In an exemplary embodiment, the code portion requiring ordered execution comprises one or more input/output operations. In a related embodiment, the execution of the code portion comprises the step of waiting for completion of the one or more input/output operations. The execution of the code portion can further include the step of receiving a notice indicating completion of the one or more input/output operations. Additionally, subsequent to the initial value of the Global Start Register being equal to the present value of the Global Finish Register, further code portions dependent upon the completion of the one or more input/output operations are executed.

In one embodiment, the step of waiting for a specified event comprises waiting for the code portion to be granted arbitration. The step of waiting for a specified event can also comprise waiting a predefined time interval.

The foregoing has outlined, rather broadly, the principles of the present invention so that those skilled in the art may better understand the detailed description of the exemplary embodiments that follow. Those skilled in the art should appreciate that they can readily use the disclosed conception and exemplary embodiments as a basis for designing or modifying other structures and methods for carrying out the same purposes of the present invention. Those skilled in the art should also realize that such equivalent constructions do not depart from the spirit and scope of the invention in its broadest form, as defined by the claims provided hereinafter.

### BRIEF DESCRIPTION OF THE DRAWINGS

For a more complete understanding of the present invention, reference is now made to the following detailed description taken in conjunction with the accompanying drawings, in which:

FIG. 1 illustrates the undesired reordering of execution of thread processes;

FIG. 2 illustrates the application of prior art principles to avoid the undesired reordering of execution of thread processes;

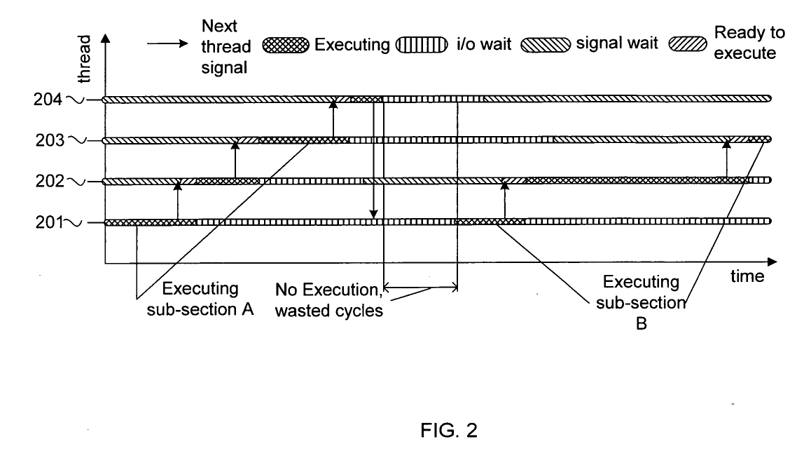

FIG. 3 illustrates an exemplary method, according to the principles of the invention, for overcoming deficiencies in the prior art principles illustrated in FIG. 2; and,

FIG. 4 illustrates the application of the principles of the invention to avoid the undesired reordering of execution of thread processes.

### DETAILED DESCRIPTION OF THE INVENTION

To overcome the problems identified, apparatus and methods will now be described for performing ordered execution in a multi-threaded processor. It has been recognized that, in order to maximize performance, the optimal behavior of a thread ordering mechanism can be viewed as a mechanism that prevents a thread that is ready to execute from doing so, if and only if the thread is about to break the ordered execution of the program; i.e., if a first thread is about to overtake one or several other threads that started to execute part of a program before it did, but the other threads would finish executing the same part of the program after the first thread, if the first thread was allowed to execute. The solution to be described behaves in this manner, using a simple mechanism and requiring little resources.

According to the basic principles of the invention, two global registers are used: a Global Start Register to keep track of the order in which threads begin executing a section of a program (or “code portion”) that requires ordered execution, and a Global Finish Register to track the order in which the threads finish executing the same section; as used herein, “global” means a shared resource among all threads, not to be confused with “global scope” of a variable. Each thread increments the Global Start Register when it begins executing that part of the program, and increments the Global Finish Register when it completes execution; it is assumed that incrementing a maximum register value causes the register value to wrap around to zero.

Each thread saves a local copy of the initial value of the Global Start Register before it increments it; as used herein, “local” means a resource dedicated to a single thread, not to be confused with “local scope” of a variable. When each thread is done executing that section of the program, it compares the saved local start register value with the Global Finish Register value. If the two register values match, indicating no reordering has occurred, the Global Finish Register is incremented and the thread can continue to execute. If the two register values do not match, however, indicating reordering of execution, the thread gives up arbitration, then waits and repeats the comparison when it's granted arbitration the next time; the comparison and wait process continues until the two register values match.

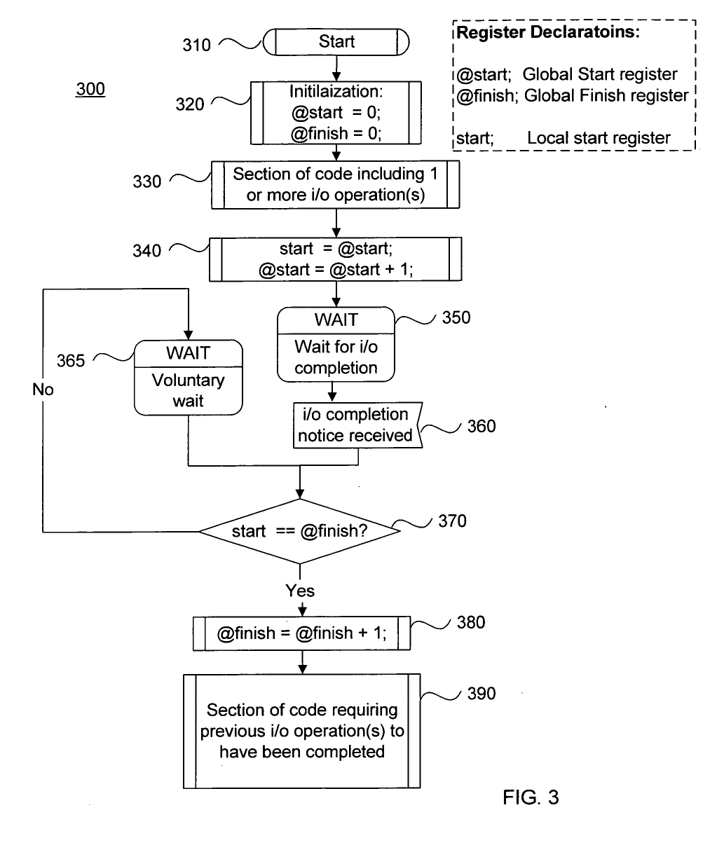

The process described is illustrated by the flowchart 300 in FIG. 3, which begins at Step 310. First, in Step 320, a Global Start Register (@start) and Global Finish Register (@finish) are initialized; in the exemplary embodiment, the registers are initialized to a value of zero. Next, in Step 330, a code portion including one or more i/o operations is encountered. For each such code portion encountered, which will require ordered execution, the initial value (start) of the Global Start Register (@start) is saved and then the Global Start Register is incremented (@start=@start+1) (Step 340). Upon completion of execution of the code portion, the initial value (start) of the Global Start Register is compared with the present value of said Global Finish Register (@finish) (Step 370). If the initial value (start) of the Global Start Register is equal to the present value of the Global Finish Register (@finish), indicating that no out-of-order execution of code portions has occurred, the Global Finish Register is incremented (Step 380. If, however, the initial value (start) of the Global Start Register is not equal to the present value of the Global Finish Register (@finish), indicating reordering of execution, then a wait state is entered (Step 365). The step of comparing (Step 370) of the initial value of the Global Start Register with the present value of the Global Finish Register is then repeated until the initial value of the Global Start Register is equal to the present value of the Global Finish Register.

In the exemplary embodiment, execution of the code portion comprises waiting for completion of the one or more input/output operations (Step 350). Execution of such code portion further comprises the step of receiving a notice indicating completion of the one or more input/output operations (Step 360). Subsequent to determining, in Step 370, that the initial value of the Global Start Register is equal to the present value of the Global Finish Register, each code portion dependent upon the completion of the one or more input/output operations is further executed (Step 390).

In an exemplary embodiment, the step of waiting for a specified event (Step 365) comprises waiting for the code portion to be granted arbitration. Alternatively, the step of waiting for a specified event (Step 365) comprises waiting a predefined time interval.

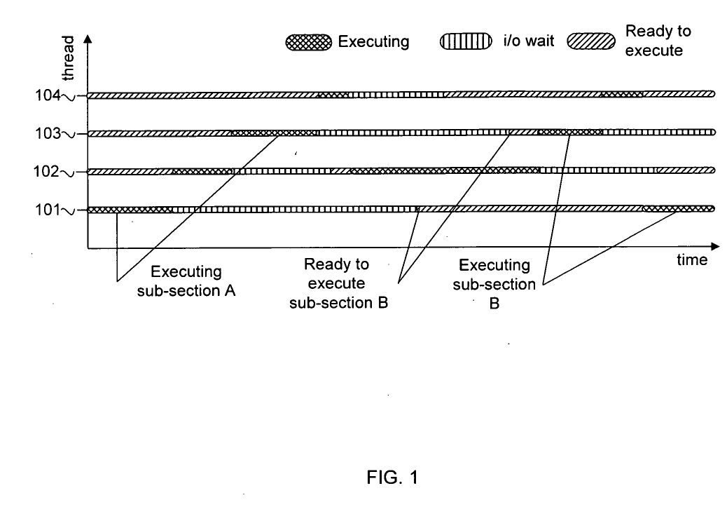

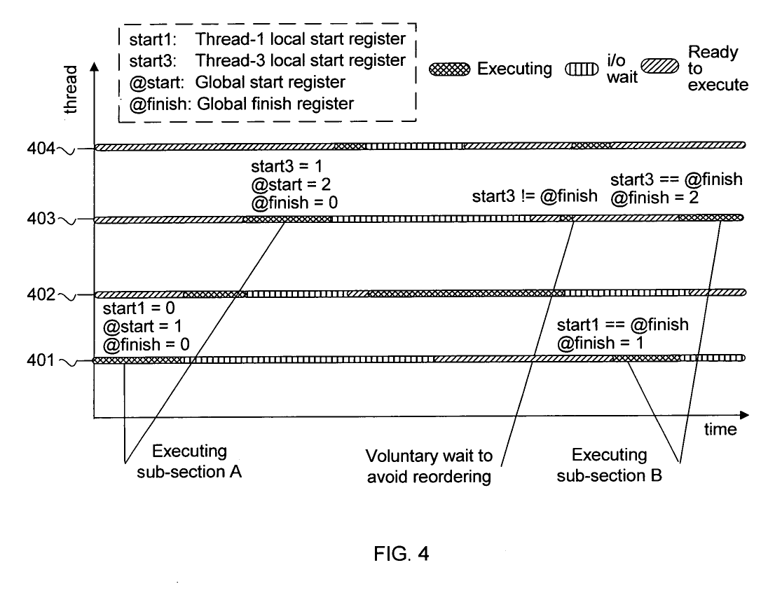

Now turning to FIG. 4, illustrated is the application of the principles of the invention to avoid the undesired reordering of execution of thread processes, applying the flexible ordered execution method illustrated in FIG. 3 to the same example as FIG. 1. Those skilled in the art will note that thread 402 and thread 404 are not stalled at any time, while thread 403 waits at one point to avoid reordering.

There are two strategies by which the flexible ordered execution method can be incorporated in the overall design of a program: program section ordering and i/o type ordering. In “program section ordering,” a program is divided into multiple sections, wherein each section of the program contains one or more i/o operations. At the end of each program section, the thread waits for the i/o operations to complete. For each program section, the ordered execution mechanism is implemented and each section has dedicated global start and finish registers (this is the strategy assumed to be used when describing the invention thus far). In “i/o type ordering,” global start and finish registers are dedicated to every i/o operation type used in a program; e.g., SRAM read, SRAM write, DRAM read, DRAM write, etc., instead of having separate global registers per program section. Everywhere an i/o operation is performed in the program, the ordering mechanism is implemented; i.e., when the i/o operation is complete the thread checks to see if reordering happened.

In general, program section ordering is better suited for programs that can be divided in a few sections. The number of i/o operations in each section is not a factor and can be rather large. In contrast, i/o type ordering is better suited for programs that need to be divided in a large number of sections, each section containing a single (or few) i/o operation. I/o type ordering assumes that the hardware guaranties order between consequent i/o operations of the same type; e.g., if two SRAM read operations are performed, it is assumed that the hardware guaranties the first one to complete before the second. In the inventor's experience, this assumption is often a valid one. In cases where this assumption does not hold true, however, the program section ordering strategy will still work and can be used advantageously.

The greatest advantage of the invention is the flexible way ordered program execution is achieved. In most cases, threads are allowed to execute independently. A thread that is ready to execute will only stall and wait if it is about to break the ordered program execution that is desired by the programmer; i.e., threads that are ready to execute will never stall unnecessarily. The result is a boost in performance that can be rather significant depending on the type of application that is being implemented.

Although the present invention has been described in detail, those skilled in the art will conceive of various changes, substitutions and alterations to the exemplary embodiments described herein without departing from the spirit and scope of the invention in its broadest form. The exemplary embodiments presented herein illustrate the principles of the invention and are not intended to be exhaustive or to limit the invention to the form disclosed; it is intended that the scope of the invention be defined by the claims appended hereto, and their equivalents.

What is claimed is:

1. A method for performing ordered execution in a multi-threaded processor, said method comprising the steps of;
initializing a Global Start Register;
initializing a Global Finish Register;
for each code portion requiring ordered execution during processing by said multi-threaded processor:
upon execution of said code portion, saving an initial value of said Global Start Register and then incrementing said Global Start Register;
upon completion of execution of said code portion, incrementing said Global Finish Register; and,
comparing said initial value of said Global Start Register with the present value of said Global Finish Register and, based on said comparison:
if said initial value of said Global Start Register is equal to said present value of said Global Finish Register, indicating that no out-of-order execution of code portions has occurred, incrementing said Global Finish Register; or,
if said initial value of said Global Start Register is not equal to said present value of said Global Finish Register, indicating reordering of execution, waiting for a specified event and then repeating said step of comparing said initial value of said Global Start Register with the present value of said Global Finish Register until said initial value of said Global Start Register is equal to said present value of said Global Finish Register.

2. The method recited in claim 1, wherein said code portion requiring ordered execution comprises one or more input/output operations.

3. The method recited in claim 2, wherein said execution of said code portion comprises the step of waiting for completion of said one or more input/output operations.

4. The method recited in claim 3, wherein said execution of said code portion further comprises the step of receiving a notice indicating completion of said one or more input/output operations.

5. The method recited in claim 4, further comprising, subsequent to said initial value of said Global Start Register being equal to said present value of said Global Finish Register, the step of executing further code portions dependent upon the completion of said one or more input/output operations.

6. The method recited in claim 1, wherein said step of waiting for a specified event comprises waiting for said code portion to be granted arbitration.

7. The method recited in claim 1, wherein said step of waiting for a specified event comprises waiting a predefined time interval.

8. A multi-threaded processor adapted to perform ordered execution, said processor comprising:
means for initializing a Global Start Register;
means for initializing a Global Finish Register;
means for saving an initial value of said Global Start Register and then incrementing said Global Start Register for each code portion requiring ordered execution upon execution of said code portion;
means for incrementing said Global Finish Register to a present value upon completion of execution of said code portion; and,
means for comparing said initial value of said Global Start Register with said present value of said Global Finish Register; and
if said initial value of said Global Start Register is equal to said present value of said Global Finish Register, indicating that no out-of-order execution of code portions has occurred, incrementing said Global Finish Register; or,
if said initial value of said Global Start Register is not equal to said present value of said Global Finish Register, indicating reordering of execution, means for waiting for a specified event and then repeating said step of comparing said initial value of said Global Start Register with the present value of said Global Finish Register until said initial value of said Global Start Register is equal to said present value of said Global Finish Register.

9. The multi-threaded processor recited in claim 8, wherein said code portion requiring ordered execution comprises one or more input/output operations.

10. The multi-threaded processor recited in claim 9, wherein said execution of said code portion comprises waiting for completion of said one or more input/output operations.

11. The multi-threaded processor recited in claim 10, wherein said execution of said code portion further comprises receiving a notice indicating completion of said one or more input/output operations.

12. The multi-threaded processor recited in claim 11, wherein, subsequent to said initial value of said Global Start Register being equal to said present value of said Global Finish Register, further code portions dependent upon the completion of said one or more input/output operations are executed.

13. The multi-threaded processor recited in claim 8, wherein said means for waiting for a specified event comprises means for waiting for said code portion to be granted arbitration.

14. The multi-threaded processor recited in claim 8, wherein said means for waiting for a specified event comprises means for waiting a predefined time interval.

15. A multi-threaded processor adapted to perform ordered execution, said multi-threaded processor operative to;
initialize a Global Start Register;
initialize a Global Finish Register;
save an initial value of said Global Start Register and then increment said Global Start Register upon execution of each code portion requiring ordered execution;
increment said Global Finish Register upon completion of execution of said code portion; and,
compare said initial value of said Global Start Register with the present value of said Global Finish Register and, based on said comparison:
if said initial value of said Global Start Register is equal to said present value of said Global Finish Register, indicating that no out-of-order execution of code portions has occurred, increment said Global Finish Register; or,
if said initial value of said Global Start Register is not equal to said present value of said Global Finish Register, indicating reordering of execution, wait for a specified event and then repeat said step of comparing said initial value of said Global Start Register with the present value of said Global Finish Register until said initial value of said Global Start Register is equal to said present value of said Global Finish Register.

16. The multi-threaded processor recited in claim 15, wherein said code portion requiring ordered execution comprises one or more input/output operations.

17. The multi-threaded processor recited in claim 16, wherein said execution of said code portion comprises waiting for completion of said one or more input/output operations.

18. The multi-threaded processor recited in claim 17, wherein said execution of said code portion further comprises receiving a notice indicating completion of said one or more input/output operations.

19. The multi-threaded processor recited in claim 18, wherein, subsequent to said initial value of said Global Start Register being equal to said present value of said Global Finish Register, said processor is further operative to execute further code portions dependent upon the completion of said one or more input/output operations.

20. The multi-threaded processor recited in claim 15, wherein said waiting for a specified event comprises waiting for said code portion to be granted arbitration.

21. The multi-threaded processor recited in claim 15, wherein said waiting for a specified event comprises waiting a predefined time interval.
